(19) United States
(12) Patent Application Publication
(10) Pub. No.: US 2024/0348729 A1
(43) Pub. Date: Oct. 17, 2024

(54) IMAGE READING DEVICE, IMAGE FORMING APPARATUS, AND IMAGE READING METHOD

(71) Applicants: Kazuki ISHIKURA, Kanagawa (JP); Ayumu HASHIMOTO, Kanagawa (JP)

(72) Inventors: Kazuki ISHIKURA, Kanagawa (JP); Ayumu HASHIMOTO, Kanagawa (JP)

(21) Appl. No.: 18/625,878

(22) Filed: Apr. 3, 2024

(30) Foreign Application Priority Data
Apr. 13, 2023 (JP) 2023-065709

(51) Int. Cl. H04N 1/00; H04N 1/028

(52) U.S. Cl. CPC H04N 1/00111; H04N 1/00082; H04N 1/02815; H04N 2201/0094

(57) ABSTRACT

An image reading device includes: a visible light source to emit visible light to an object; an invisible light source to emit invisible light to the object; a first imaging element to receive light reflected from the object to capture a visible image; a second imaging element to receive light reflected from the object to capture an invisible image; and circuitry to remove a visible component included in the invisible image captured by the second imaging element using the visible image captured by the first imaging element.

### CROSS-REFERENCE TO RELATED APPLICATION

This patent application is based on and claims priority pursuant to 35 U.S.C. § 119(a) to Japanese Patent Application No. 2023-065709, filed on Apr. 13, 2023, in the Japan Patent Office, the entire disclosure of which is hereby incorporated by reference herein.

### BACKGROUND

### Technical Field

The present disclosure relates to an image reading device, an image forming apparatus, and an image reading method.

### Related Art

In an image reading device using a document illumination lamp including an infrared component, a technology of removing the infrared component from a visible image including the infrared component to correct the visible image is disclosed.

There is also as technique of removing an infrared component from an invisible image using an infrared (IR) pass filter. When the infrared component is removed from the invisible image using the IR pass filter, the infrared component may not be completely removed such that the visible component slightly remains, resulting in an inappropriate invisible image.

### SUMMARY

Example embodiments include an image reading device including: a visible light source to emit visible light to an object; an invisible light source to emit invisible light to the object; a first imaging element to receive light reflected from the object to capture a visible image; a second imaging element to receive light reflected from the object to capture an invisible image; and circuitry to remove a visible component included in the invisible image captured by the second imaging element using the visible image captured by the first imaging element.

Example embodiments include an image forming apparatus including the above-described image reading device.

Example embodiments include an image reading method performed by an image reading device, the method including: with a visible light source of the image reading device, emitting visible light to an object; with an invisible light source of the image reading device, emitting invisible light to the object; with a first imaging element of the image reading device, receiving light reflected from the object to capture a visible image; with a second imaging element of the image reading device, receiving light reflected from the object to capture an invisible image; and removing a visible component included in the invisible image captured with the second imaging element using the visible image captured with the first imaging element.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an example configuration of an image forming apparatus according to a first embodiment;

FIG. 2 is a schematic view of configurations of an image reading device and an automatic document feeder (ADF) according to the first embodiment;

FIG. 3 is a block diagram illustrating electric connection of components included in the image reading device according to the first embodiment;

FIG. 4 is a graph presenting an example of the spectral sensitivity characteristics of an image sensor;

FIG. 5 is a graph presenting an example of removing visible components using an IR pass filter;

FIG. 6 is a functional block diagram illustrating functions of the image reading device according to the first embodiment;

FIG. 7 is a flowchart presenting a flow of processing by the image reading device according to the first embodiment;

FIG. 8 is a diagram illustrating an example effect of removing visible components from an infrared component with the visible components mixed;

FIG. 9 is a functional block diagram illustrating functions of an image reading device according to a second embodiment;

FIG. 10 is a graph presenting an example of the spectral reflectance of a reference white plate; and

FIG. 11 is a flowchart presenting a flow of processing by the image reading device according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a” “an”, and “the” are intended to include the plural forms as well, unless the context clearly indicates otherwise.

Hereinafter, embodiments of an image reading device, an image forming apparatus, and an image reading method are described in detail referring to the accompanying drawings.

### First Embodiment

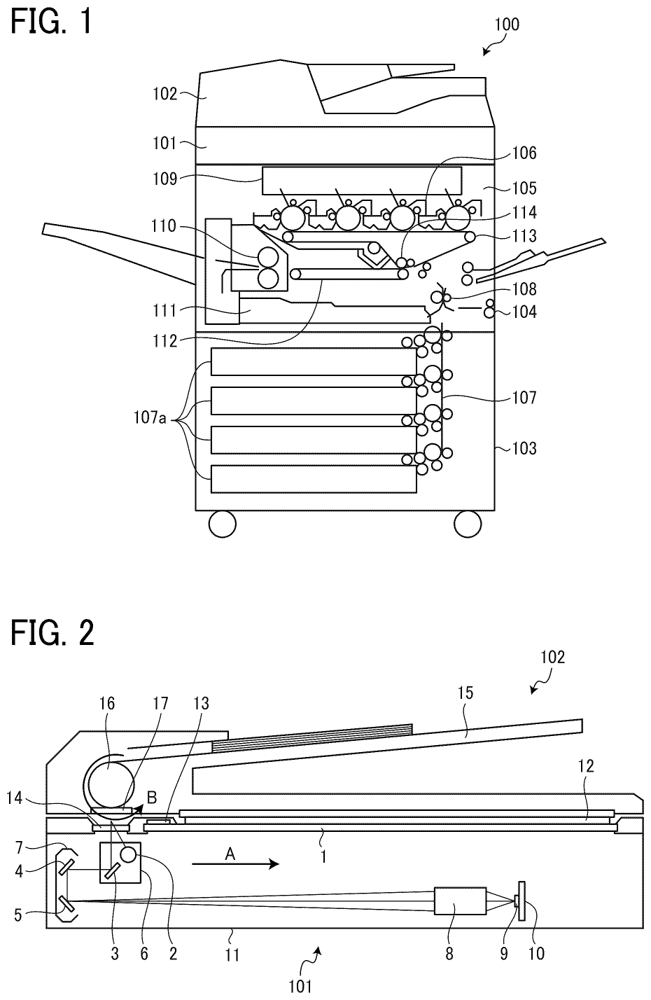

FIG. 1 is a schematic view of an example configuration of an image forming apparatus 100 according to a first embodiment.

In FIG. 1, the image forming apparatus 100 is generally called a multifunction peripheral, printer, or product (MFP) having at least two of copying, printing, scanning, and facsimile functions.

The image forming apparatus 100 includes an image reading device 101, an automatic document feeder (ADF) 102 atop the image reading device 101, and an image forming device 103 below the image reading device 101. In order to describe an internal configuration of the image forming device 103, FIG. 1 illustrates the internal configuration of the image forming device 103 from which an external cover is removed.

The ADF 102 is a document supporter that positions, at a reading position, a document (object) or an original including an image to be read. The ADF 102 automatically feeds the document placed on a table to the reading position. The image reading device 101 reads the document fed by the ADF 102 at the predetermined reading position. The image reading device 101 includes a platen (or an exposure glass) as an upper surface of the image reading device 101. The platen serves as a document supporter on which a document is placed. The image reading device 101 reads the document on the platen, that is, at the reading position. Specifically, the image reading device 101 is a scanner that includes a light source, an optical system, and an image sensor such as a charge-coupled device (CCD) inside. In the image reading device 101, the light source emits light to illuminate the document. The light reflected from the document passes through the optical system and reaches the image sensor, which reads the light. Thus, the image reading device 101 reads an image of the document.

The image forming device 103 prints the image of the document read by the image reading device 101. In other words, the image forming device 103 forms an image in accordance with information from the image reading device 101. The image forming device 103 includes a manual feed roller pair 104 through which a recording medium is manually inserted and a recording medium supply unit 107 that supplies a recording medium. The recording medium supply unit 107 includes an assembly that sends out recording media one by one from vertically-aligned input trays 107a. The recording medium thus supplied is sent to a secondary transfer belt 112 via a registration roller pair 108.

A transfer device 114 transfers a toner image from an intermediate transfer belt 113 onto the recording medium conveyed on the secondary transfer belt 112.

The image forming device 103 also includes an optical writing device 109, image forming units 105 employing a tandem system for colors of yellow, magenta, cyan, and black (Y, M, C, K), the intermediate transfer belt 113, and the secondary transfer belt 112. Specifically, in an image forming process, the image forming units 105 each render a latent image written by the optical writing device 109 visible as a toner image and forms the toner image on the intermediate transfer belt 113.

Specifically, the image forming units 105 for Y, M, C, and K include four rotatable drum-shaped photoconductors for Y, M, C, and K, respectively. Each of the four photoconductors is surrounded by various pieces of image forming equipment 106 such as a charging roller, a developing device, a primary transfer roller, a cleaner unit, and a neutralizer. The pieces of image forming equipment 106 function around each of the four photoconductors to form a toner image on the corresponding photoconductor and transfer the toner image onto the intermediate transfer belt 113. Specifically, the primary transfer rollers transfer the toner images from the respective photoconductors onto the intermediate transfer belt 113. As a consequence, a composite toner image is formed on the intermediate transfer belt 113.

The intermediate transfer belt 113 is entrained around a drive roller and a driven roller and disposed so as to pass through primary transfer nips between the four photoconductors and the respective primary transfer rollers. As the intermediate transfer belt 113 rotates, the toner images primarily transferred onto the intermediate transfer belt 113 are conveyed to a secondary transfer device, which secondarily transfers the toner images as a composite toner image onto a recording medium on the secondary transfer belt 112. As the secondary transfer belt 112 rotates, the recording medium is conveyed to a fixing device 110. The fixing device 110 fixes the composite toner image as a color image onto the recording medium. Finally, the recording medium is ejected onto an output tray disposed outside a housing of the image forming device 103. Note that, in the case of duplex printing, a reverse assembly 111 reverses the front and back sides of the recording medium and sends out the reversed recording medium onto the secondary transfer belt 112.

The image forming device 103 is not limited to an electrophotographic image forming device that forms an image by electrophotography as described above. Alternatively, the image forming device 103 may be an inkjet image forming device that forms an image in an inkjet system.

Now, description is given of the image reading device 101 and the ADF 102.

FIG. 2 is a schematic view of configurations of the image reading device 101 and the ADF 102. As illustrated in FIG. 2, the image reading device 101 includes, in a housing 11, a sensor substrate 10 provided with an image sensor 9 serving as an imaging element, a lens unit 8 for forming an image on the image sensor 9, a first carriage 6, and a second carriage 7. The image sensor 9 is, for example, a CCD or a complementary metal oxide semiconductor (CMOS) image sensor. The first carriage 6 includes a light source 2, which is a light emitting diode (LED), and a mirror 3. The second carriage 7 includes mirrors 4 and 5.

The image reading device 101 further includes a platen 1 and a reference white plate 13 as an upper surface of the image reading device 101. The reference white plate 13 serves as a reference member. The reference white plate 13 is formed to be long in a main-scanning direction, and is used for correcting, for example, unevenness in density of reading in the main-scanning direction in a reading optical system or the like. The image reading device 101 also includes a platen 14 serving as a sheet-through reading slit for reading a document fed by the ADF 102.

The ADF 102 is coupled to the image reading device 101 via a hinge or the like so as to be opened and closed with respect to the platen 1.

The ADF 102 includes a document tray 15 serving as a document table on which a document bundle including a plurality of documents can be placed. The ADF 102 also includes a separation feeder including a feeding roller 16 that separates the documents one by one from the document bundle placed on the document tray 15 and automatically feeds the separated document toward the platen 14.

The ADF 102 further includes a background plate 17 at a position facing the platen 14. The background plate 17 causes the density in the main-scanning direction to be uniform.

In the image forming apparatus 100 having the above-described configuration, in a scan mode of scanning an image surface of a document 12 to read an image of the document 12, the image reading device 101 emits light upward from the light source 2 while moving the first carriage 6 and the second carriage 7 from standby positions (home positions) in a sub-scanning direction (direction A). In this case, the second carriage 7 moves at a speed that is ½ of the speed of the first carriage 6 to keep the length of an optical path from the platen 1 to the image sensor 9 constant. The first carriage 6 and the second carriage 7 form an image of the light reflected from the document 12, on the image sensor 9 via the lens unit 8. The image sensor 9 photoelectrically converts the image into a signal and outputs the signal. A signal processor in the subsequent stage converts the signal into a digital signal. Thus, the image of the document 12 is read, and a digital image is obtained.

In contrast, in a sheet-through mode of automatically feeding a document and reading an image of the document, the image reading device 101 moves the first carriage 6 and the second carriage 7 to positions below the platen 14. Then, a document placed on the document tray 15 of the ADF 102 is automatically fed in a direction indicated by arrow B (sub-scanning direction) by the feeding roller 16. The image reading device 101 emits light upward to the document from the light source 2 at the position of the platen 14. The first carriage 6 and the second carriage 7 form an image of the light reflected from the document, on the image sensor 9 via the lens unit 8. The image sensor 9 photoelectrically converts the image into a signal and outputs the signal. The signal processor in the subsequent stage converts the signal into a digital signal. Thus, the image of the document fed by the ADF 102 is read, and a digital image is obtained. The document whose image has been read in this way is ejected through an ejection port.

The image reading device 101 reads the light reflected from the reference white plate 13 through illumination with the light source 2 and sets a reference before an image is read in the scan mode or the sheet-through mode, such as when the power is turned on. Specifically, the image reading device 101 moves the first carriage 6 to the position directly below the reference white plate 13, turns on the light source 2, and causes an image of the light reflected from the reference white plate 13 to be formed on the image sensor 9. The image sensor 9 converts the light reflected from the reference white plate 13 into an analog signal. The signal processor in the subsequent stage converts the analog signal into a digital signal. Thus, the reference white plate 13 is read, and shading correction when an image of a document is read is performed based on the reading result (digital signal).

When the ADF 102 includes a conveyance belt, a document can be automatically fed by the ADF 102 to the reading position on the platen 1, and an image of the document can be read even in the scan mode.

In the present embodiment, the image reading device 101 is described as a device that reads light reflected from an object; however, the image reading device 101 may read light transmitted through an object.

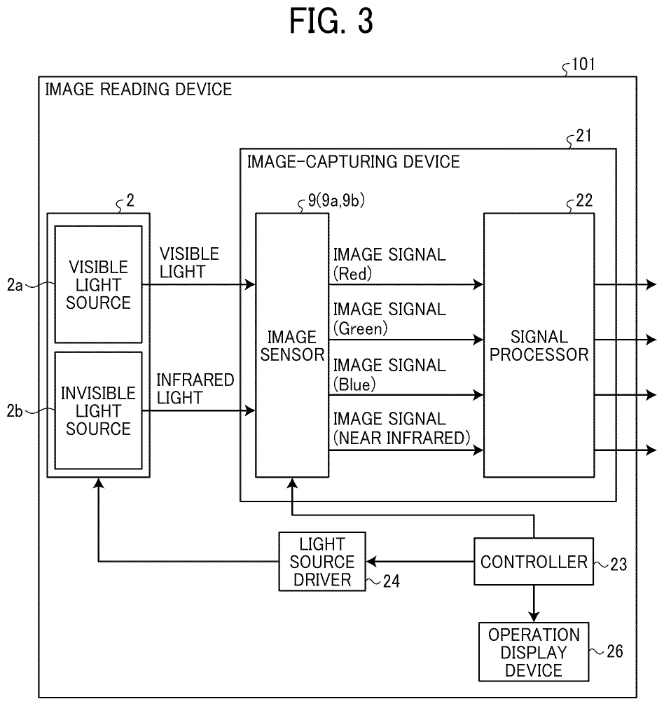

FIG. 3 is a block diagram illustrating electric connection of components included in the image reading device 101. As illustrated in FIG. 3, the image reading device 101 includes the light source 2, an image-capturing device 21, a controller 23, a light source driver 24, and an operation display device 26. The light source driver 24 drives the light source 2.

The light source 2 includes a visible light source 2a that emits visible light having wavelengths mainly in visible (red, green, and blue) ranges, and an invisible light source 2b that emits invisible light (near infrared light) having wavelengths in a near infrared (NIR) range.

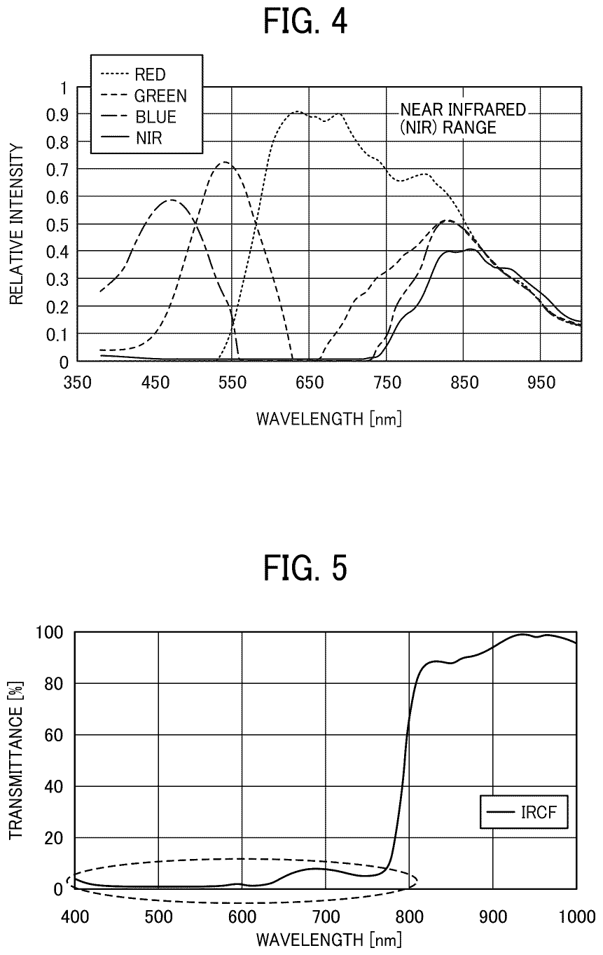

FIG. 4 is a graph presenting an example of the spectral sensitivity characteristics of an image sensor. As presented in FIG. 4, a typical silicon image sensor has sensitivity in a near infrared range (in a range of from about 750 nm to about 1100 nm). Thus, a special reading device is not used for light in the near infrared range (in the range of from about 750 nm to about 1100 nm), and an image can be captured with an image sensor of a scanner mounted on a typical MFP. Since there is no adverse effect on a human body, it is easy to introduce such an image sensor in terms of safety risk.

The image-capturing device 21 includes the image sensor 9 and a signal processor 22. The image sensor 9 can capture an image of light in the visible and invisible wavelength ranges as described above.

The image sensor 9 receives light obtained by decomposing incident light into visible light (red, green, and blue) and invisible light (infrared light) on a wavelength basis via a color filter or the like. The image sensor 9 includes a first image sensor (visible sensor) 9a serving as a first imaging element, and a second image sensor (invisible sensor) 9b serving as a second imaging element. The first image sensor 9a converts the decomposed light into electric signals of main visible components (red, green, and blue) and a near infrared component. The second image sensor 9b converts the decomposed light into an electric signal of a near infrared component.

The second image sensor (invisible sensor) 9b removes the visible components (red, green, and blue) using an IR pass filter to generate a proper image (infrared image) of an IR component.

FIG. 5 is a graph presenting an example of removing visible components using the IR pass filter. As presented in FIG. 5, even when the IR pass filter or the like is used, the visible components are not completely removed, and the visible components slightly remain.

Thus, there is a disadvantage that a proper image (infrared image) of an IR component cannot be generated.

In the present embodiment, an example of using a near infrared (NIR) image as an invisible image is described; however, the wavelength range used for an invisible image is not limited.

The controller 23 controls components of the light source driver 24, the image sensor 9, the signal processor 22, and the operation display device 26. The controller 23 is implemented by, for example, circuitry or processing circuitry.

Although details will be described later, the signal processor 22 executes various types of signal processing on an image signal output from the image sensor 9.

The operation display device 26 is a user interface such as a display for a user to confirm various information and a user interface such as a keyboard for the user to input information.

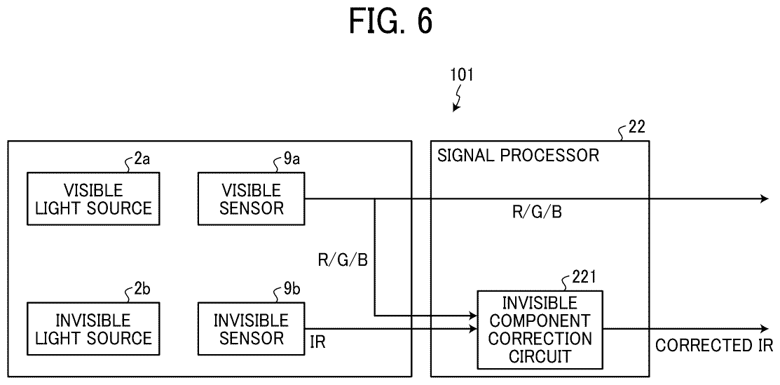

FIG. 6 is a functional block diagram illustrating functions of the image reading device 101. As illustrated in FIG. 6, the signal processor 22 of the image reading device 101 includes an invisible component correction circuit 221. The signal processor 22 may be implemented by, for example, circuitry or processing circuitry.

The invisible component correction circuit 221 generally corrects, based on an image (visible image) of R, G, and B components captured by the first image sensor (visible sensor) 9a and an image (infrared image) of an IR component captured by the second image sensor (invisible sensor) 9b, the image of the IR component.

The first image sensor 9a is an image sensor for mainly acquiring visible components. The second image sensor 9b is an image sensor for acquiring an invisible component. The data read by the second image sensor 9b becomes an invisible image (infrared image) with slightly remaining visible components as described with reference to FIG. 5. To obtain a high-quality invisible image (infrared image), the invisible component correction circuit 221 uses the visible image output from the first image sensor (visible sensor) 9a and the invisible image (infrared image) output from the second image sensor (invisible sensor) 9b, which are obtained by simultaneous reading, to remove the visible components from the invisible image (infrared image) with the slightly remaining visible components output from the second image sensor (invisible sensor) 9b.

A flow of processing in the image reading device 101 is described below in detail.

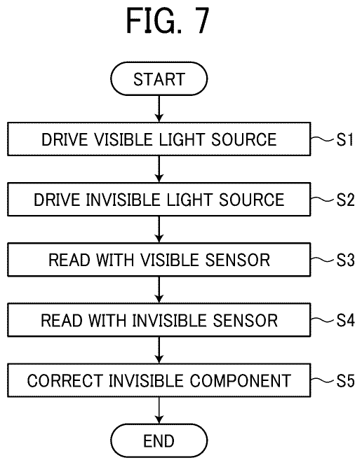

FIG. 7 is a flowchart presenting a flow of processing by the image reading device 101. As presented in FIG. 7, the controller 23 of the image reading device 101 drives the visible light source 2a via the light source driver 24 (step S1). Simultaneously, the controller 23 of the image reading device 101 drives the invisible light source 2b via the light source driver 24 (step S2). Thus, the visible light source 2a and the invisible light source 2b are simultaneously turned on to emit visible light and invisible light. Reflected light of the visible light and reflected light of the invisible light are emitted on the visible sensor 9a and the invisible sensor 9b.

The controller 23 of the image reading device 101 controls the visible sensor 9a to read the reflected light of the visible light source 2a and the invisible light source 2b that are simultaneously turned on and capture an image (visible image) of R, G, and B components (step S3). Simultaneously, the controller 23 of the image reading device 101 controls the invisible sensor 9b to read the reflected light of the visible light source 2a and the invisible light source 2b that are simultaneously turned on and capture an image (infrared image) of an IR component (step S4).

The invisible component correction circuit 221 of the signal processor 22 executes image correction on the invisible component (IR component) to remove the visible components from the invisible image (infrared image) with the slightly remaining visible components output from the invisible sensor 9b using the image (visible image) of the R, G, and B components captured by the visible sensor 9a and the image (infrared image) of the IR component captured by the invisible sensor 9b (step S5).

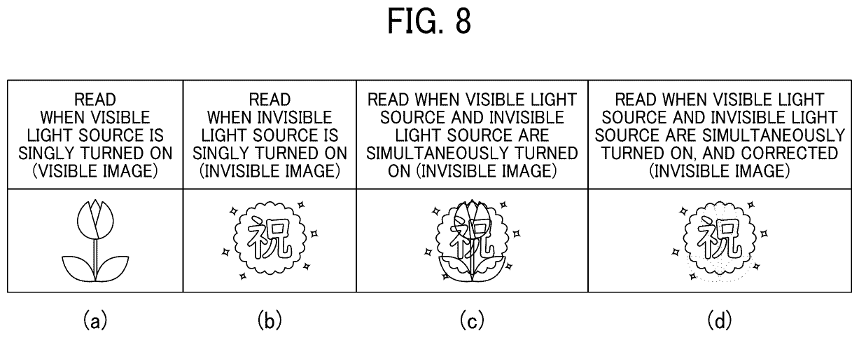

FIG. 8 is a diagram illustrating an effect of removing visible components from an infrared component with the visible components mixed. Referring to FIG. 8, description is given using a picture in which a latent image readable with invisible light is embedded. FIG. 8(a) illustrates a visible image (read when a visible light source is singly turned on). FIG. 8(b) illustrates an ideal image of an invisible image (read when an invisible light source is singly turned on). FIG. 8(c) illustrates a poor image of an invisible image (read when the visible light source and the invisible light source are simultaneously turned on). FIG. 8(d) illustrates a proper image after correction of the invisible image (read when the visible light source and the invisible light source are simultaneously turned on, and corrected).

In a case of reading when the visible light source and the invisible light source are simultaneously turned on of related art as illustrated in FIG. 8(c), the IR pass filter cannot remove the visible components. Thus, a picture of the visible components is mixed with the invisible image, and a poor image in which the visible image in FIG. 8(a) is superposed on the invisible image in FIG. 8(b) is generated.

In contrast, when the invisible component correction circuit 221 of the signal processor 22 removes the visible components from the infrared component with the visible components mixed, a proper image close to the ideal state illustrated in FIG. 8(b) can be generated as illustrated in FIG. 8(d).

As described above, according to the present embodiment, the visible components and the infrared component that are simultaneously read are used to remove the visible components from the infrared component with the visible components mixed. Thus, the visible components that are not completely removed even with the IR pass filter can be corrected, and an infrared image with proper image quality can be generated.

### Second Embodiment

A second embodiment will be described below.

The second embodiment differs from the first embodiment in that the invisible component correction circuit 221 includes a correction coefficient generation circuit. Description of part of the second embodiment identical to that of the first embodiment will be omitted, and part of the second embodiment different from that of the first embodiment will be described.

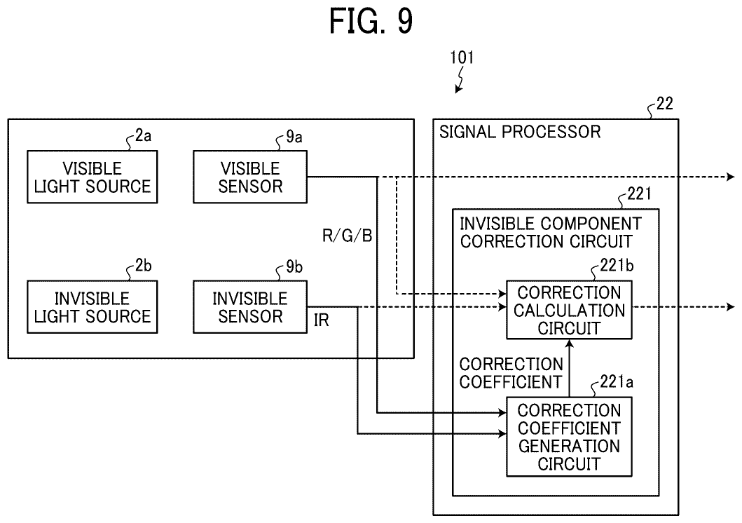

FIG. 9 is a functional block diagram illustrating functions of an image reading device 101 according to the second embodiment. As illustrated in FIG. 9, the invisible component correction circuit 221 includes a correction coefficient generation circuit 221a and a correction calculation circuit 221b.

The correction coefficient generation circuit 221a generates a correction coefficient based on a composite signal of R channel (Rch), B channel (Bch), and G channel (Gch) and a signal of NR channel (NIRch) when the visible light source 2a is singly turned on, as pre-processing of removing visible components from an infrared component with the visible components mixed using the invisible component correction circuit 221 described in the first embodiment. The correction coefficient generation circuit 221a transmits the generated correction coefficient to the correction calculation circuit 221b. The visible light source 2a is singly turned on, when the visible light source 2a is turned on while the invisible light source 2b is not turned on.

The correction calculation circuit 221b performs correction calculation to remove visible components from an infrared component with the visible components mixed based on the correction coefficient transmitted from the correction coefficient generation circuit 221a.

Description is given of that an infrared signal and a visible signal can be corrected by using the correction coefficient generated by the correction coefficient generation circuit 221a.

Inputs to the visible sensor 9a having sensitivity in the visible range of the image reading device 101 include visible light and infrared light. Inputs to the invisible sensor 9b having sensitivity in the invisible range of the image reading device 101 also include visible light and infrared light. In this case, the visible light input to the invisible sensor 9b is an unwanted component and is a factor of deterioration in image quality.

The visible light input to the invisible sensor 9b can be calculated based on a reading result of an image (visible image) of R, G, and B components by the visible sensor 9a when the visible light source 2a and the invisible light source 2b are simultaneously turned on, and a reading result of an image (visible image) of R, G, and B components by the visible sensor 9a when the visible light source 2a is singly turned on. This is because the ratio between visible components and an invisible component of the light from the visible light source 2a is obtained based on reading results of R, G, B channels and an NIR channel by the visible sensor 9a when the visible light source 2a is singly turned on.

That is, when “RGB+NIR” represents a reading result of the visible sensor 9a when the visible light source 2a and the invisible light source 2b are simultaneously turned on, and “RGB′+NIR′” represents a reading result of the invisible sensor 9b when the visible light source 2a and the invisible light source 2b are simultaneously turned on, by setting a correction coefficient k′ to a value satisfying RGB′−k′(RGB)=0, visible components (RGB′) can be removed from an infrared component with the visible components mixed using the following expression. An error by the amount of k′NIR is generated at the subtraction, and hence the state is not completely ideal; however, the disadvantage can be addressed.

$${RGB}^{′} + {NIR}^{′} - {k}^{′} ( RGB + NIR ) = {NIR}^{′} - {k}^{′} ( NIR )$$

An example of calculation of the correction coefficient k′ that is generated by the correction coefficient generation circuit 221a is described below. Reference characters ref_NIR(x), ref_R(x), ref_G(x), and ref_B(x) represent reading results of the respective channels when the visible light source 2a is singly turned on.

$${k}^{′} ( ref\_NIR ( x ) ) / ( average ( ref\_R ( x ) + ref\_G ( x ) + ref\_B ( x ) ) )$$

An example of removal calculation by the correction calculation circuit 221b is described below. Reference characters input_NIR(x), input_R(x), input_G(x), and input_B(x) represent reading results of the respective channels when the visible light source 2a and the invisible light source 2b are simultaneously turned on. Reference character average( ) indicates a calculation result of the average.

$$output\_N = input\_N ( x ) - {k}^{′} \times average ( input\_R ( x ) + input\_G ( x ) + input\_B ( x ) ) .$$

As described above, the correction coefficient k′ generated by the correction coefficient generation circuit 221a is calculated based on the ratio between the average value of an R channel, a G channel, and a B channel and the value of an invisible channel (in this example, NIR channel) of the visible sensor 9a. In this way, by taking the average value of the R, G, and B channels, the influence of noise of a specific color when the correction coefficient is generated can be prevented.

As described above, the visible light input to the invisible sensor 9b is removed by the subtraction, and an invisible image (infrared image) from which unwanted RGB components (visible components) have been removed can be generated.

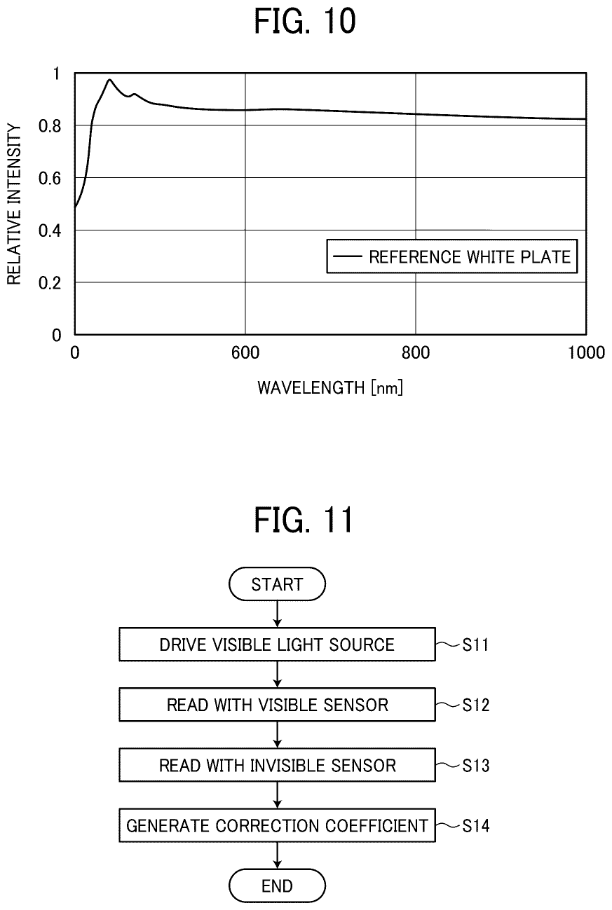

FIG. 10 is a graph presenting an example of the spectral reflectance of the reference white plate 13. As presented in FIG. 10, it is found that the reference white plate 13 has a high spectral reflectance even in the infrared range, and the spectral reflectance has a flat characteristic from the visible range to the invisible range. An image-capturing target when the correction coefficient is generated desirably does not have specific absorption because it is desirable to obtain the ratio between the visible components and the invisible component when the visible light source 2a is singly turned on. Thus, the reference white plate 13 desirably has a characteristic as presented in FIG. 10. By using the reading result of the reference white plate 13 in this way, a stable reading result can be obtained, and the precision of the correction coefficient can be increased.

A flow of processing in the image reading device 101 is described below in detail.

FIG. 11 is a flowchart presenting a flow of processing by the image reading device 101. As presented in FIG. 11, the controller 23 of the image reading device 101 drives the visible light source 2a via the light source driver 24 (step S11). The controller 23 of the image reading device 101 does not drive the invisible light source 2b.

The controller 23 of the image reading device 101 controls the visible sensor 9a to read the reflected light of the visible light source 2a that is singly turned on and capture an image (visible image) of R, G, and B components (step S12). Simultaneously, the controller 23 of the image reading device 101 controls the invisible sensor 9b to read the reflected light of the visible light source 2a that is singly turned on and capture an image (infrared image) of an IR component (step S13).

The invisible component correction circuit 221 (correction coefficient generation circuit 221a) of the signal processor 22 generates a correction coefficient based on a composite signal of Rch, Bch, and Gch and a signal of NIRch when the visible light source 2a is singly turned on, and transmits the generated correction coefficient to the correction calculation circuit 221b (step S14).

Then, as described in the first embodiment, the invisible component correction circuit 221 (correction calculation circuit 221b) of the signal processor 22 performs correction calculation to remove visible components (RGB′) from an infrared component with the visible components mixed (RGB′+NIR′), based on the correction coefficient transmitted from the correction coefficient generation circuit 221a.

As described above, according to the present embodiment, the visible components and the infrared component that are simultaneously read are used to remove the visible components from the infrared component with the visible components mixed. Thus, the visible components that are not completely removed even with the IR pass filter can be corrected, and an invisible image (for example, infrared image) with proper image quality can be generated.

The example has been described in which the image forming apparatus according to any of the embodiments of the present disclosure is applied to the MFP having at least two of the copying, printing, scanning, and facsimile functions. However, the image forming apparatus can be applied to an image forming apparatus such as any one of a copier, a printer, a scanner, and a facsimile apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), general purpose circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image reading device comprising:
a visible light source to emit visible light to an object;
an invisible light source to emit invisible light to the object;
a first imaging element to receive light reflected from the object to capture a visible image;
a second imaging element to receive light reflected from the object to capture an invisible image; and
circuitry configured to remove a visible component included in the invisible image captured by the second imaging element using the visible image captured by the first imaging element.

2. The image reading device according to claim 1, wherein the circuitry is configured to generate a correction coefficient, and remove the visible component included in the invisible image using the correction coefficient.

3. The image reading device according to claim 2, wherein the circuitry is configured to generate the correction coefficient using the visible image captured by the first imaging element and the invisible image captured by the second imaging element before the visible component included in the invisible image is removed.

4. The image reading device according to claim 2, wherein the visible image from which the visible component is removed is captured by the first imaging element when the visible light source is turned on while the invisible light source is not turned on.

5. The image reading device according to claim 4, wherein the circuitry is configured to calculate the correction coefficient based on a ratio between an average value of an R channel, a G channel, and a B channel and a value of an invisible channel of the first imaging element.

6. The image reading device according to claim 4, wherein the first imaging element and the second imaging element are each configured to capture a member having a spectral reflectance with a flat characteristic from a visible range to an invisible range, to generate the visible image and the invisible image each to be used for generating the correction coefficient.

7. The image reading device according to claim 4, wherein the first imaging element and the second imaging element are each configured to capture a reference white plate that is used for shading correction when an image is read, to generate the visible image and the invisible image each to be used for generating the correction coefficient.

8. The image reading device according to claim 1, wherein the invisible light includes a near infrared light.

9. An image forming apparatus comprising:
the image reading device according to claim 1; and
an image forming device to form an image read by the image reading device.

10. An image reading method performed by an image reading device, the method comprising:
with a visible light source of the image reading device, emitting visible light to an object;
with an invisible light source of the image reading device, emitting invisible light to the object;
with a first imaging element of the image reading device, receiving light reflected from the object to capture a visible image;
with a second imaging element of the image reading device, receiving light reflected from the object to capture an invisible image; and
removing a visible component included in the invisible image captured with the second imaging element using the visible image captured with the first imaging element.
